(19) United States
(12) Patent Application Publication
(10) Pub. No.: US 2015/0317937 A1
(43) Pub. Date: Nov. 5, 2015

(54) DATA DRIVING CIRCUIT FOR DRIVING LIQUID CRYSTAL PANEL AND DRIVING METHOD OF LIQUID CRYSTAL PANEL

(71) Applicant: Shenzhen China Star Optoelectronics Technology Co. Ltd., Shenzhen, Guangdong (CN)

(72) Inventors: Jiang Zhu, Shenzhen City (CN); Dongsheng Guo, Shenzhen City (CN)

(21) Appl. No.: 14/364,292

(22) PCT Filed: May 8, 2014
(86) PCT No.: PCT/CN2014/077076

§ 371 Date: Jun. 10, 2014

(30) Foreign Application Priority Data
May 4, 2014 (CN) 201410185428.8

(51) Int. Cl. G09G 3/36

(52) U.S. Cl. CPC G09G 3/3614; G09G 3/3685; G09G 2310/027; G09G 2320/0276; G09G 2320/0626

(57) ABSTRACT

A data driving circuit includes a processing module for determining grayscale levels will be displayed by pixels on an nth scanning line and judging driving voltage polarities of the pixels; a storing module for storing duty cycles of charging voltages corresponding to grayscale levels of pixels on a liquid crystal panel; a switching module for reading duty cycles of charging voltages corresponding to the grayscale levels will be displayed by the pixels on the nth scanning line from the storing module and controlling charging times of the pixels according to the readout charging voltages; and a voltage selecting module for selecting charging voltages corresponding to the pixels on the nth scanning line according to the processing module determined grayscale levels will be displayed by the pixels and judged driving voltage polarities of the pixels, and supplying the selected charging voltages to the pixels through the switching module.

### TECHNICAL FIELD

The present invention relates to the field of liquid crystal display, and particularly to a data driving circuit for driving a liquid crystal panel and a driving method of liquid crystal panel.

### DESCRIPTION OF RELATED ART

Generally speaking, the human eye has a much higher sensitivity to the brightness change in a relatively dark environment than that in a relatively bright environment. This biological instinct facilitates our ancient ancestors when the night comes still having enough ability to discern approaching danger in the dark.

By some modern visual experiments, we have known that a relationship formula between perception of human eye and brightness is: Y=AX^{Γ}, where Y indicates the brightness, A indicates the perception of human eye, Γ is about in the range of 2.2-2.5. The relationship formula customarily is termed as “Γ curve (or referred to as gamma curve)”, and (1/A)^{1/Γ} indicates the sensitivity of the perception of human eye to brightness change.

Since the above-described visual characteristic of human eye, during the display process of liquid crystal display apparatus, it is needed to adjust the brightness of displayed color, so that the human eye can observe a better display effect. In order to obtain the linear response relationship of brightness and perception of human eye, it is necessary to configure the liquid crystal display apparatus to adopt a gamma curve adjustment. In the gamma curve, the longitudinal axis represents brightness (or transmittance), and the horizontal axis generally represents grayscale (or digitized video data).

Nowadays, the proposed solutions of improving display quality of liquid crystal display apparatus most are gamma corrections performed in source driver ICs. The conventional gamma correction is to generate a set of gamma voltages by pre-designing a set of gamma resistances during circuit design to match with an internal gamma resistance integrated in the source driver IC. After the source driver IC receives digitized video data from a timer controller TCON, it refers to the set of gamma voltages and then outputs grayscale response driving voltages on corresponding data lines, and thereby achieving the purpose of displaying different grayscales.

When the conventional liquid crystal display apparatus charges liquid crystal pixels, each liquid crystal pixel is charged by a fixed voltage, and the fixed voltage is generated by the gamma correction circuit. Such gamma circuit is equipped with a series of resistors and thereby generates a set of gamma voltages by voltage-dividing of the resistors. When the source driver IC charges each liquid crystal pixel, the gamma voltages are outputted as reference voltages for the charge of each liquid crystal pixel. For example, with regard to a 6-bit output signal, when wanting to display a certain grayscale level e.g., sixtieth grayscale level L60 on a liquid crystal pixel, the source driver IC would find out the voltage V60 from the gamma voltages corresponding to L60 according to the digitized video data from the TCON, and output the voltage of V60 on the liquid crystal pixel to charge the liquid crystal pixel. However, in the prior art, in one aspect, since the quantity of gamma voltages is large, the expense of resistors cause a cost. In another aspect, the gamma resistors would excessively occupy the space of PCB board, resulting in a large area of the PCB board and influencing the size of liquid crystal panel. Moreover, the layout design of PCB board becomes complexity and the wiring of gamma voltages is difficult to be realized.

### SUMMARY

In view of the above shortcomings of prior art, an objective of the present invention is to provide a data driving circuit for driving a liquid crystal panel. The data driving circuit includes a processing module, a storing module, a switching module and a voltage selecting module. The processing module is for determining grayscale levels will be displayed by pixels on an nth scanning line and judging driving voltage polarities of the pixels on the nth scanning line. The storing module is for storing duty cycles of charging voltages corresponding to grayscale levels of pixels on the liquid crystal panel. The switching module is for reading out duty cycles of charging voltages corresponding to the grayscale levels will be displayed by the pixels on the nth scanning line from the storing module, and controlling charging times of the pixels on the nth scanning line according to the readout duty cycles of the charging voltages corresponding to the grayscale levels will be displayed by the pixels on the nth scanning line. The voltage selecting module is for selecting charging voltages corresponding to the pixels on the nth scanning line according to the grayscale levels will be displayed by the pixels on the nth scanning determined by the processing module and the driving voltage polarities of the pixels on the nth scanning line judged by the processing module, and supplying the selected charging voltages corresponding to the pixels on the nth scanning line through the switching module to corresponding pixels on the nth scanning line.

In an exemplary embodiment, when the processing module judges that there is a positive polarity voltage driven pixel among the pixels on the nth scanning line and determines that a grayscale level will be displayed by the positive polarity voltage driven pixel falls in between [(max+3)/2]th grayscale level to [max]th grayscale level, the voltage selecting module selects a first charging voltage and supplies the first charging voltage through the switching module to the positive polarity voltage driven pixel, the switching module controls a charging time of the positive polarity voltage driven pixel according to a duty cycle of the first charging voltage corresponding to the grayscale level will be displayed by the positive polarity voltage driven pixel readout from the storing module. The [max]th grayscale level indicates the maximum grayscale level determined by the processing module.

In an exemplary embodiment, when the processing module judges that there is a positive polarity voltage driven pixel among the pixels on the nth scanning line and determines that a grayscale level will be displayed by the positive polarity voltage driven pixel falls in between 0th grayscale level to [(max+1)/2]th grayscale level, the voltage selecting module selects a second charging voltage and supplies the second charging voltage through the switching module to the positive polarity voltage driven pixel, the switching module controls a charging time of the positive polarity voltage driven pixel according to a duty cycle of the second charging voltage corresponding to the grayscale level will be displayed by the positive polarity voltage driven pixel readout from the storing module. A [max]th grayscale level indicates the maximum grayscale level determined by the processing module.

In an exemplary embodiment, when the processing module judges that there is a negative polarity voltage driven pixel among the pixels on the nth scanning line and determines that a grayscale level will be displayed by the negative polarity voltage driven pixel falls in between 0th grayscale level to [(max+1)/2]th grayscale level, the voltage selecting module selects a third charging voltage and supplies the third charging voltage through the switching module to the negative polarity voltage driven pixel, the switching module controls a charging time of the negative polarity voltage driven pixel according to a duty cycle of the third charging voltage corresponding to the grayscale level will be displayed by the negative polarity voltage driven pixel readout from the storing module. A [max]th grayscale level indicates the maximum grayscale level determined by the processing module.

In an exemplary embodiment, when the processing module judges that there is a negative polarity voltage driven pixel among the pixels on the nth scanning line and determines that a grayscale level will be displayed by the negative polarity voltage driven pixel falls in between [(max+3)/2]th grayscale level to [max]th grayscale level, the voltage selecting module selects a fourth charging voltage and supplies the fourth charging voltage through the switching module to the negative polarity voltage driven pixel, the switching module controls a charging time of the negative polarity voltage driven pixel according to a duty cycle of the fourth charging voltage corresponding to the grayscale level will be displayed by the negative polarity voltage driven pixel readout from the storing module. The [max]th grayscale level indicates the maximum grayscale level determined by the processing module.

Another objective of the present invention is to provide a driving method of liquid crystal panel. The driving method includes: determining grayscale levels will be displayed by pixels on an nth scanning line and judging driving voltage polarities of the pixels on the nth scanning line; reading out duty cycles of charging voltages corresponding to the grayscale levels will be displayed by the pixels on the nth scanning line; and selecting charging voltages corresponding to the pixels on the nth scanning line according to the determined grayscale levels will be displayed by the pixels on the nth scanning and the judged driving voltage polarities of the pixels on the nth scanning line, and supplying the selected charging voltages corresponding to the pixels on the nth scanning line to corresponding pixels on the nth scanning line.

In an exemplary embodiment, when it is judged that there is a positive polarity voltage driven pixel among the pixels on the nth scanning line and determined that a grayscale level will be displayed by the positive polarity voltage driven pixel falls in between [(max+3)/2]th grayscale level to [max]th grayscale level, selecting a first charging voltage, supplying the first charging voltage to the positive polarity voltage driven pixel, and controlling a charging time of the positive polarity voltage driven pixel according to a readout duty cycle of the first charging voltage corresponding to the grayscale level will be displayed by the positive polarity voltage driven pixel. The [max]th grayscale level indicates the maximum grayscale level of determining.

In an exemplary embodiment, when it is judged that there is a positive polarity voltage driven pixel among the pixels on the nth scanning line and determined that a grayscale level will be displayed by the positive polarity voltage driven pixel falls in between 0th grayscale level to [(max+1)/2]th grayscale level, selecting a second charging voltage, supplying the second charging voltage to the positive polarity voltage driven pixel, and controlling a charging time of the positive polarity voltage driven pixel according to a readout duty cycle of the second charging voltage corresponding to the grayscale level will be displayed by the positive polarity voltage driven pixel. A [max]th grayscale level indicates the maximum grayscale level of determining.

In an exemplary embodiment, when it is judged that there is a negative polarity voltage driven pixel among the pixels on the nth scanning line and determined that a grayscale level will be displayed by the negative polarity voltage driven pixel falls in between 0th grayscale level to [(max+1)/2]th grayscale level, selecting a third charging voltage, supplying the third charging voltage to the negative polarity voltage driven pixel, and controlling a charging time of the negative polarity voltage driven pixel according to a readout duty cycle of the third charging voltage corresponding to the grayscale level will be displayed by the negative polarity voltage driven pixel. A [max]th grayscale level indicates the maximum grayscale level of determining.

In an exemplary embodiment, when it is judged that there is a negative polarity voltage driven pixel among the pixel on the nth scanning line and determined that a grayscale level will be displayed by the negative polarity voltage driven pixel falls in between [(max+3)/2]th grayscale level to [max]th grayscale level, selecting a fourth charging voltage, supplying the fourth charging voltage to the negative polarity voltage driven pixel, and controlling a charging time of the negative polarity voltage driven pixel according to a readout duty cycle of the fourth charging voltage corresponding to the grayscale level will be displayed by the negative polarity voltage driven pixel. The [max]th grayscale level indicates the maximum grayscale level of determining.

Accordingly, with regard to the data driving circuit for driving liquid crystal panel and the driving method of liquid crystal panel of the present invention, there is no necessary need of the gamma resistor when designing the data driving circuit, the cost is down and the area of PCB is reduced. Moreover, the wiring space of PCB design is increased and the complexity of PCB design is reduced.

### BRIEF DESCRIPTION OF THE DRAWINGS

The above embodiments will become more readily apparent to those ordinarily skilled in the art after reviewing the following detailed description and accompanying drawings.

FIG. 1 is a schematic block diagram of a data driving circuit for driving a liquid crystal panel in accordance with an exemplary embodiment of the present invention.

FIG. 2 is a schematic flow chart of a driving method of liquid crystal panel in accordance with an exemplary embodiment of the present invention.

### DETAILED DESCRIPTION OF EMBODIMENTS

The present invention will now be described more specifically with reference to the following embodiments. It is to be noted that the following descriptions of embodiments are presented herein for purpose of illustration and description only. It is not intended to be exhaustive or to be limited to the precise form disclosed.

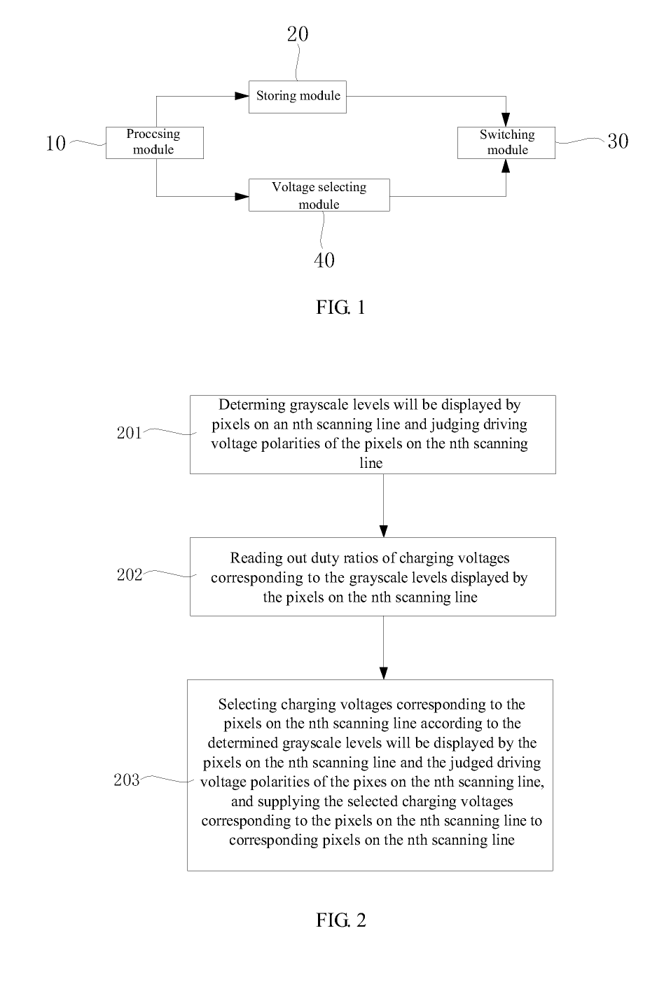

FIG. 1 is a schematic block diagram of a data driving circuit for driving a liquid crystal panel in accordance with an exemplary embodiment.

Referring to FIG. 1, the data driving circuit (or referred to as source driver IC) in accordance with the exemplary embodiment includes: a processing module 10, a storing module 20, a switching module 30 and a voltage selecting module 40.

Specifically, the processing module 10 may include a shift register, a first set of data registers and a second set of data registers. The quantity of the data registers in the first and second sets of data registers is equal to the column quantity of pixels arranged in a matrix on the liquid crystal panel. The shift register controls an action time of the data driving circuit according to a horizontal clock signal (H clock) and a horizontal synchronizing signal (H sync) to sequentially turn on latched first set of data registers. The first set of data registers receive and sequentially store digitized video data (or grayscales) will be displayed by pixels on the nth (herein, n is a natural number) scanning line, after the digitized video data all are sequentially stored in the first set of data registers, relying on a next horizontal synchronizing signal, all the data (i.e., the digitized video data will be displayed by the pixels on the nth scanning line) simultaneously transfer to the second set of data registers. At this time, the shift register is triggered by the next horizontal synchronizing signal to store digitized video data (or grayscales) will be displayed by pixels on the (n+1)th scanning line to the first set of data registers. The second set of data registers calculate out grayscale levels of the pixels on the nth scanning line according to the received digitized video data will be displayed by the pixels on the nth scanning line, and judge driving voltage polarities for the pixels on the nth scanning line.

The storing module 20 is configured (i.e., structured and arranged) for storing duty cycles of charging voltages corresponding to grayscale levels of pixels (or referred to as all levels of grayscale) on the liquid crystal panel.

The switching module 30 may be a metal-oxide-semiconductor (MOS) transistor(s). The switching module 30 is configured for reading out duty cycles of charging voltages corresponding to grayscale levels of pixels on the nth scanning line from the storing module 20 and controlling charging times of the pixels on the nth scanning line according to the readout duty cycles of charging voltages corresponding to the grayscales of the pixels on the nth scanning line. Herein, the duty cycle of charging voltage is a ratio of a working time of charging voltage (i.e., duration of high level signal) to the whole pixel charging time in a pixel charging process.

The voltage selecting module 40 may be a digital to analog converter (or referred to as multiplexer). The voltage selecting module 40 is configured for selecting charging voltages corresponding to the pixels on the nth scanning line according to the grayscale levels will be displayed by the pixels on the nth scanning and the driving voltage polarities of the pixels on the nth scanning line after reading out the grayscale levels of the pixels on the nth scanning line and the driving voltage polarities of the pixels on the nth scanning line from the processing module 10, and further for supplying the charging voltages corresponding to the pixels on the nth scanning line through the switching module 30 to corresponding pixels on the nth scanning line.

When the processing module 10 judges that there is a positive polarity voltage driven pixel (i.e., generally a pixel will be driven by positive polarity voltage) among the pixels on the nth scanning line and calculates out that a grayscale level of the positive polarity voltage driven pixel falls in between [(max+3)/2]th grayscale level to [max]th grayscale level, the voltage selecting module 40 selects a first charging voltage and supplies the first charging voltage through the switching module 30 to the positive polarity voltage driven pixel on the nth scanning line, the switching module 30 controls a charging time of the positive polarity voltage driven pixel according to a duty cycle of the first charging voltage corresponding to the grayscale level of the positive polarity voltage driven pixel on the nth scanning line readout from the storing module 20, so that the positive polarity voltage driven pixel on the nth scanning line can carry out different grayscale display. Where, the [max]th grayscale level indicates the maximum grayscale level calculated out by the processing module 10.

When the processing module 10 judges out that there is a positive polarity voltage driven pixel among the pixels on the nth scanning line and calculates out that a grayscale level of the positive polarity voltage driven pixel falls in between 0th grayscale level to [(max+1)/2]th grayscale level, the voltage selecting module 40 selects a second charging voltage and supplies the second charging voltage through the switching module 30 to the positive polarity voltage driven pixel on the nth scanning line, the switching module 30 controls a charging time of the positive polarity voltage driven pixel according to a duty cycle of the second charging voltage corresponding to the grayscale level of the positive polarity voltage driven pixel on the nth scanning line readout from the storing module 20, so that the positive polarity voltage driven pixel on the nth scanning line can carry out different grayscale display. Where, a [max]th grayscale level indicates the maximum grayscale level being able to be calculated out by the processing module 10.

Herein, it is indicated that the first charging voltage has a value larger than that of the second charging voltage.

In addition, when the processing module 10 judges out that there is a negative polarity voltage driven pixel among the pixels on the nth scanning line and calculates out that a grayscale level of the negative polarity voltage driven pixel falls in between 0th grayscale level to [(max+1)/2]th grayscale level, the voltage selecting module 40 selects a third charging voltage and supplies the third charging voltage through the switching module 30 to the negative polarity voltage driven pixel on the nth scanning line, the switching module 30 controls a charging time of the negative polarity voltage driven pixel according to a duty cycle of the third charging voltage corresponding to the grayscale level of the negative polarity voltage driven pixel on the nth scanning line readout from the storing module 20, so that the negative polarity voltage driven pixel on the nth scanning line can carry out different grayscale display. Where, a [max]th grayscale level indicates the maximum grayscale level being able to be calculated out by the processing module 10.

When the processing module 10 judges out that there is a negative polarity voltage driven pixel among the pixels on the nth scanning line and calculates out that a grayscale level of the negative polarity voltage driven pixel that falls in between [(max+3)/2]th grayscale level to [max]th grayscale level, the voltage selecting module 40 selects out a fourth charging voltage and supplies the fourth charging voltage through the switching module 30 to the negative polarity voltage driven pixel on the nth scanning line, the switching module 30 controls a charging time of the negative polarity voltage driven pixel according to a duty cycle of the fourth charging voltage corresponding to the grayscale level of the negative polarity voltage driven pixel on the nth scanning line readout from the storing module 20, so that the negative polarity voltage driven pixel on the nth scanning line can carry out different grayscale display. Where, the [max]th grayscale level indicates the maximum grayscale level being able to be calculated out by the processing module 10.

Herein, it is indicated that the third charging voltage has a value smaller than that of the fourth charging voltage.

FIG. 2 is a schematic flow chart of a driving method of liquid crystal panel in accordance with an exemplary embodiment of the present invention.

Referring to FIG. 1 and FIG. 2, in an operation 201, the processing module 10 determines grayscale levels will be displayed by pixels on an nth scanning line and judges driving voltage polarities of the pixels on the nth scanning line. In the operation, the processing module 10 may include a shift register, a first set of data registers and a second set of data registers. The quantity of the data registers in the first and second sets of data registers is identical to the column quantity of pixels arranged in a matrix on the liquid crystal panel.

The shift register controls an action time of the data driving circuit according to a horizontal clock signal (H clock) and a horizontal synchronizing signal (H sync) to sequentially turn on latched first set of data registers. The first set of data registers receive and sequentially store digitized video data (or grayscale levels) will be displayed by the pixels on the nth scanning line, and after the digitized video data all are sequentially stored in the first set of data registers, relying on a next horizontal synchronizing signal, all the data (i.e., the digitized video data (or grayscale levels) will be displayed by the pixels on the nth scanning line) simultaneously transfer to the second set of data registers. At this time, the shift register is triggered by the next horizontal synchronizing signal to store digitized video data (or grayscale levels) will be displayed by pixels on the (n+1)th scanning line to the first set of data registers. The second set of data registers calculate out gray scale levels of the pixels on the nth scanning line according to the received digitized video data will be displayed by the pixels on the nth scanning line, and judge driving voltage polarities for the pixels on the nth scanning line.

In an operation 202, the switching module 30 reads out duty cycles of charging voltages corresponding to the grayscale levels will be displayed by the pixels on the nth scanning line. Herein, the storing module 20 is configured for storing duty cycles of charging voltages corresponding to grayscale levels of pixels (or referred to as all levels of grayscale) on the liquid crystal panel. The switching module 30 reads out the duty cycles of charging voltages corresponding to the grayscale levels of the pixels on the nth scanning line from the storing module 20 and controls charging times of the pixels on the nth scanning line according to the readout duty cycles of charging voltages corresponding to the grayscale levels of the pixels on the nth scanning line. The duty cycle of charging voltage indicates a ratio of a working time of charging voltage (i.e., duration of high level signal) to the whole pixel charging time in a pixel charging process.

In an operation 203, the voltage selecting module 40 selects charging voltages corresponding to the pixels on the nth scanning line according to the grayscale levels will be displayed by the pixels on the nth scanning line determined by the processing module 10 and the driving voltage polarities of the pixels on the nth scanning line judged by the processing module 10, and further supplies the selected charging voltages corresponding to the pixels on the nth scanning line through the switching module 30 to corresponding pixels on the nth scanning line.

Furthermore, in the above operation, when the processing module 10 judges that there is a positive polarity voltage driven pixel among the pixels on the nth scanning line and calculates out that a grayscale level of the positive polarity voltage driven pixel falls in between [(max+3)/2]th grayscale level to [max]th grayscale level, the voltage selecting module 40 selects a first charging voltage and supplies the first charging voltage through the switching module 30 to the positive polarity voltage driven pixel on the nth scanning line, the switching module 30 controls a charging time of the positive polarity voltage driven pixel according to a duty cycle of the first charging voltage corresponding to the grayscale level of the positive polarity voltage driven pixel on the nth scanning line readout from the storing module 20, so that the positive polarity voltage driven pixel on the nth scanning line can carry out different grayscale display. Where, the [max]th grayscale level indicates the maximum grayscale level calculated out by the processing module 10.

When the processing module 10 judges that there is a positive polarity voltage driven pixel among the pixels on the nth scanning line and calculates out that a grayscale level of the positive polarity voltage driven pixel falls in between 0th grayscale level to [(max+1)/2]th grayscale level, the voltage selecting module 40 selects a second charging voltage and supplies the second charging voltage through the switching module 30 to the positive polarity voltage driven pixel on the nth scanning line, the switching module 30 controls a charging time of the positive polarity voltage driven pixel according to a duty cycle of the second charging voltage corresponding to the grayscale level of the positive polarity voltage driven pixel on the nth scanning line readout from the storing module 20, so that the positive polarity voltage driven pixel on the nth scanning line can carry out different grayscale display. Where, a [max]th grayscale level indicates the maximum grayscale level being able to be calculated out by the processing module 10.

Herein, it is indicated that the first charging voltage has a value is larger than that of the second charging voltage.

In addition, when the processing module 10 judges that there is a negative polarity voltage driven pixel among the pixels on the nth scanning line and calculates out that a grayscale level of the negative polarity voltage driven pixel falls in between 0th grayscale level to [(max+1)/2]th grayscale level, the voltage selecting module 40 selects a third charging voltage and supplies the third charging voltage through the switching module 30 to the negative polarity voltage driven pixel on the nth scanning line, the switching module 30 controls a charging time of the negative polarity voltage driven pixel according to a duty cycle of the third charging voltage corresponding to the grayscale level of the negative polarity voltage driven pixel on the nth scanning line readout from the storing module 20, so that the negative polarity voltage driven pixel on the nth scanning line can carry out different grayscale display. Where, a [max]th grayscale level indicates the maximum grayscale level being able to be calculated out by the processing module 10.

When the processing module 10 judges that there is a negative polarity voltage driven pixel among the pixels on the nth scanning line and calculates out that a grayscale level of the negative polarity voltage driven pixel that falls in between [(max+3)/2]th grayscale level to [max]th grayscale level, the voltage selecting module 40 selects a fourth charging voltage and supplies the fourth charging voltage through the switching module 30 to the negative polarity voltage driven pixel on the nth scanning line, the switching module 30 controls a charging time of the negative polarity voltage driven pixel according to a duty cycle of the fourth charging voltage corresponding to the grayscale level of the negative polarity voltage driven pixel on the nth scanning line readout from the storing module 20, so that the negative polarity voltage driven pixel on the nth scanning line can carry out different grayscale display. Where, the [max]th grayscale level indicates the maximum grayscale level being able to be calculated out by the processing module 10.

Herein, it is indicated that the third charging voltage has value smaller than that of the fourth charging voltage.

In summary, according to the various embodiments of the present invention, since the switching module 30 supplies the charging voltages of the pixels on the nth scanning line selected by the voltage selecting module 40 to the pixels on the nth scanning line, and further controls the charging times of the pixels on the nth scanning line according to the duty cycles of charging voltages corresponding to the grayscale levels of the pixels on the nth scanning line, so that the pixels on the nth scanning line can carry out different grayscale display. Accordingly, there is no necessary need of the gamma resistor when designing the data driving circuit, the expense of resistor is saved and the area of PCB is reduced so that the cost is down. Moreover, the wiring space of PCB design is increased and the complexity of PCB design is reduced, so that the product development cycle is considerably shortened.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A data driving circuit for driving a liquid crystal panel, comprising:
a processing module, configured for determining grayscale levels will be displayed by pixels on an nth scanning line and judging driving voltage polarities of the pixels on the nth scanning line;
a storing module, configured for storing duty cycles of charging voltages corresponding to grayscale levels of pixels on the liquid crystal panel;
a switching module, configured for reading out duty cycles of charging voltages corresponding to the grayscale levels will be displayed by the pixels on the nth scanning line from the storing module, and for controlling charging times of the pixels on the nth scanning line according to the readout duty cycles of the charging voltages corresponding to the grayscale levels will be displayed by the pixels on the nth scanning line; and
a voltage selecting module, configured for selecting the charging voltages corresponding to the pixels on the nth scanning line according to the grayscale levels will be displayed by the pixels on the nth scanning line determined by the processing module and the driving voltage polarities of the pixels on the nth scanning line judged by the processing module, and for supplying the selected charging voltages corresponding to the pixels on the nth scanning line through the switching module to corresponding pixels on the nth scanning line.

2. The data driving circuit according to claim 1, wherein when the processing module judges that there is a positive polarity voltage driven pixel among the pixels on the nth scanning line and determines that a grayscale level will be displayed by the positive polarity voltage driven pixel falls in between [(max+3)/2]th grayscale level to [max]th grayscale level, the voltage selecting module selects a first charging voltage and supplies the first charging voltage through the switching module to the positive polarity voltage driven pixel, the switching module controls a charging time of the positive polarity voltage driven pixel according to a duty cycle of the first charging voltage corresponding to the grayscale level will be displayed by the positive polarity voltage driven pixel readout from the storing module, and the [max]th grayscale level indicates the maximum grayscale level determined by the processing module.

3. The data driving circuit according to claim 1, wherein when the processing module judges that there is a positive polarity voltage driven pixel among the pixels on the nth scanning line and determines that a grayscale level will be displayed by the positive polarity voltage driven pixel falls in between 0th grayscale level to [(max+1)/2]th grayscale level, the voltage selecting module selects a second charging voltage and supplies the second charging voltage through the switching module to the positive polarity voltage driven pixel, the switching module controls a charging time of the positive polarity voltage driven pixel according to a duty cycle of the second charging voltage corresponding to the grayscale level will be displayed by the positive polarity voltage driven pixel readout from the storing module, and a [max]th grayscale level indicates the maximum grayscale level determined by the processing module.

4. The data driving circuit according to claim 1, wherein when the processing module judges that there is a negative polarity voltage driven pixel among the pixels on the nth scanning line and determines that a grayscale level will be displayed by the negative polarity voltage driven pixel falls in between 0th grayscale level to [(max+1)/2]th grayscale level, the voltage selecting module selects a third charging voltage and supplies the third charging voltage through the switching module to the negative polarity voltage driven pixel, the switching module controls a charging time of the negative polarity voltage driven pixel according to a duty cycle of the third charging voltage corresponding to the grayscale level will be displayed by the negative polarity voltage driven pixel readout from the storing module, and a [max]th grayscale level indicates the maximum grayscale level determined by the processing module.

5. The data driving circuit according to claim 1, wherein when the processing module judges that there is a negative polarity voltage driven pixel among the pixels on the nth scanning line and determines that a grayscale level will be displayed by the negative polarity voltage driven pixel falls in between [(max+3)/2]th grayscale level to [max]th grayscale level, the voltage selecting module selects a fourth charging voltage and supplies the fourth charging voltage through the switching module to the negative polarity voltage driven pixel, the switching module controls a charging time of the negative polarity voltage driven pixel according to a duty cycle of the fourth charging voltage corresponding to the grayscale level will be displayed by the negative polarity voltage driven pixel readout from the storing module, and the [max]th grayscale level indicates the maximum grayscale level determined by the processing module.

6. The data driving circuit according to claim 2, wherein when the processing module judges that there is a positive polarity voltage driven pixel among the pixels on the nth scanning line and determines that a grayscale level will be displayed by the positive polarity voltage driven pixel falls in between 0th grayscale level to [(max+1)/2]th grayscale level, the voltage selecting module selects a second charging voltage and supplies the second charging voltage through the switching module to the positive polarity voltage driven pixel, the switching module controls a charging time of the positive polarity voltage driven pixel according to a duty cycle of the second charging voltage corresponding to the grayscale level will be displayed by the positive polarity voltage driven pixel readout from the storing module, and a [max]th grayscale level indicates the maximum grayscale level determined by the processing module.

7. The data driving circuit according to claim 6, wherein when the processing module judges that there is a negative polarity voltage driven pixel among the pixels on the nth scanning line and determines that a grayscale level will be displayed by the negative polarity voltage driven pixel falls in between 0th grayscale level to [(max+1)/2]th grayscale level, the voltage selecting module selects a third charging voltage and supplies the third charging voltage through the switching module to the negative polarity voltage driven pixel, the switching module controls a charging time of the negative polarity voltage driven pixel according to a duty cycle of the third charging voltage corresponding to the grayscale level will be displayed by the negative polarity voltage driven pixel readout from the storing module, and a [max]th grayscale level indicates the maximum grayscale level determined by the processing module.

8. The data driving circuit according to claim 7, wherein when the processing module judges that there is a negative polarity voltage driven pixel among the pixels on the nth scanning line and determines that a grayscale level will be displayed by the negative polarity voltage driven pixel falls in between [(max+3)/2]th grayscale level to [max]th grayscale level, the voltage selecting module selects a fourth charging voltage and supplies the fourth charging voltage through the switching module to the negative polarity voltage driven pixel, the switching module controls a charging time of the negative polarity voltage driven pixel according to a duty cycle of the fourth charging voltage corresponding to the grayscale level will be displayed by the negative polarity voltage driven pixel readout from the storing module, and the [max]th grayscale level indicates the maximum grayscale level determined by the processing module.

9. A driving method of liquid crystal panel, comprising:
determining grayscale levels will be displayed by pixels on an nth scanning line and judging driving voltage polarities of the pixels on the nth scanning line;
reading out duty cycles of charging voltages corresponding to the grayscale levels will be displayed by the pixels on the nth scanning; and
selecting charging voltages corresponding to the pixels on the nth scanning line according to the determined grayscale levels will be displayed by the pixels on the nth scanning line and the judged driving voltage polarities of the pixels on the nth scanning line, and supplying the selected charging voltages corresponding to the pixels on the nth scanning line to corresponding pixels on the nth scanning line.

10. The driving method according to claim 9, wherein when it is judged that there is a positive polarity voltage driven pixel among the pixels on the nth scanning line and determined that a grayscale level will be displayed by the positive polarity voltage driven pixel falls in between [(max+3)/2]th grayscale level to [max]th grayscale level, selecting a first charging voltage, supplying the first charging voltage to the positive polarity voltage driven pixel, and controlling a charging time of the positive polarity voltage driven pixel according to a readout duty cycle of the first charging voltage corresponding to the grayscale level will be displayed by the positive polarity voltage driven pixel, and wherein the [max]th grayscale level indicates the maximum grayscale level of determining.

11. The driving method according to claim 9, wherein when it is judged that there is a positive polarity voltage driven pixel among the pixels on the nth scanning line and determined that a grayscale level will be displayed by the positive polarity voltage driven pixel falls in between 0th grayscale level to [(max+1)/2]th grayscale level, selecting a second charging voltage, supplying the second charging voltage to the positive polarity voltage driven pixel, and controlling a charging time of the positive polarity voltage driven pixel according to a readout duty cycle of the second charging voltage corresponding to the grayscale level will be displayed by the positive polarity voltage driven pixel, and wherein a [max]th grayscale level indicates the maximum grayscale level of determining.

12. The driving method according to claim 9, wherein when it is judged that there is a negative polarity voltage driven pixel among the pixels on the nth scanning line and determined that a grayscale level will be displayed by the negative polarity voltage driven pixel falls in between 0th grayscale level to [(max+1)/2]th grayscale level, selecting a third charging voltage, supplying the third charging voltage to the negative polarity voltage driven pixel, and controlling a charging time of the negative polarity voltage driven pixel according to a readout duty cycle of the third charging voltage corresponding to the grayscale level will be displayed by the negative polarity voltage driven pixel, and wherein a [max]th grayscale level indicates the maximum grayscale level of determining.

13. The driving method according to claim 9, wherein when it is judged that there is a negative polarity voltage driven pixel among the pixels on the nth scanning line and determined that a grayscale level will be displayed by the negative polarity voltage driven pixel falls in between [(max+3)/2]th grayscale level to [max]th grayscale level, selecting a fourth charging voltage, supplying the fourth charging voltage to the negative polarity voltage driven pixel, and controlling a charging time of the negative polarity voltage driven pixel according to a readout duty cycle of the fourth charging voltage corresponding to the grayscale level will be displayed by the negative polarity voltage driven pixel, and wherein the [max]th grayscale level indicates the maximum grayscale level of determining.

14. The driving method according to claim 10, wherein when it is judged that there is a positive polarity voltage driven pixel among the pixels on the nth scanning line and determined that a grayscale level will be displayed by the positive polarity voltage driven pixel falls in between 0th grayscale level to [(max+1)/2]th grayscale level, selecting a second charging voltage, supplying the second charging voltage to the positive polarity voltage driven pixel, and controlling a charging time of the positive polarity voltage driven pixel according to a readout duty cycle of the second charging voltage corresponding to the grayscale level will be displayed by the positive polarity voltage driven pixel, and wherein a [max]th grayscale level indicates the maximum grayscale level of determining.

15. The driving method according to claim 14, wherein when it is judged that there is a negative polarity voltage driven pixel among the pixels on the nth scanning line and determined that a grayscale level will be displayed by the negative polarity voltage driven pixel falls in between 0th grayscale level to [(max+1)/2]th grayscale level, selecting a third charging voltage, supplying the third charging voltage to the negative polarity voltage driven pixel, and controlling a charging time of the negative polarity voltage driven pixel according to a readout duty cycle of the third charging voltage corresponding to the grayscale level will be displayed by the negative polarity voltage driven pixel, and wherein a [max]th grayscale level indicates the maximum grayscale level of determining.

16. The driving method according to claim 15, wherein when it is judged that there is a negative polarity voltage driven pixel among the pixels on the nth scanning line and determined that a grayscale level will be displayed by the negative polarity voltage driven pixel falls in between [(max+3)/2]th grayscale level to [max]th grayscale level, selecting a fourth charging voltage, supplying the fourth charging voltage to the negative polarity voltage driven pixel, and controlling a charging time of the negative polarity voltage driven pixel according to a readout duty cycle of the fourth charging voltage corresponding to the grayscale level will be displayed by the negative polarity voltage driven pixel, and wherein the [max]th grayscale level indicates the maximum grayscale level of determining.
